(19) United States
(12) Patent Application Publication
(10) Pub. No.: US 2011/0309693 A1
(43) Pub. Date: Dec. 22, 2011

(54) MOLDED MOTOR AND ELECTRIC VEHICLE

(75) Inventors: Takeshi Nagao, Osaka (JP); Kenji Taguchi, Osaka (JP); Hiroaki Sagara, Osaka (JP); Tetsuji Ueta, Osaka (JP); Takashi Uchino, Osaka (JP)

(73) Assignee: SANYO Electric Co., Ltd., Moriguchi-shi, Osaka (JP)

(21) Appl. No.: 13/142,126

(22) PCT Filed: Dec. 25, 2009
(86) PCT No.: PCT/JP2009/071674

§ 371 Date: Sep. 6, 2011

(30) Foreign Application Priority Data
Dec. 26, 2008 (JP) 2008-334813

(51) Int. Cl. H02K 5/02

(52) U.S. Cl. 310/43

(57) ABSTRACT

A first motor case (52) comprises a partition unit (52A) of annular shape that is formed on a surface facing a first space (P1) that is formed between the first motor case (52) and a gear case (70). The gear case (70) is fitted into the partition unit (52A).

### TECHNICAL FIELD

The present invention relates to a molded motor including a resin-molded stator and an electric vehicle including the molded motor.

### BACKGROUND ART

Conventionally, a light and compact molded motor has been widely used as a driving source for an electric vehicle, a washing machine, etc.

The molded motor includes: an annular stator, and a rotor arranged in the space formed inside the stator. The stator includes a plurality of teeth molded with a resin material. The rotor revolves around the shaft center of the stator.

Generally, the stator and the rotor are contained within a case in order to support the dust-proofness and waterproof property (see Patent Document 1, for example).

Moreover, for a purpose of effectively utilizing the power of the molded motor, it is possible to consider the use of a reduction mechanism configured to reduce and output a rotation speed of the rotor.

However, when the reduction mechanism is attached outside the molded motor, the size of an apparatus increases. On the other hand, when the reduction mechanism is contained inside the molded motor, it is needed to skillfully inhibit, for example, a leakage of oil injected inside the reduction mechanism by air-tightly sealing the reduction mechanism, together with the rotor, inside the molded motor.

### PRIOR ART DOCUMENT

### Patent Document

Patent Document 1 Japanese Unexamined Patent Application Publication

### SUMMARY OF THE INVENTION

A molded motor according to an aspect of the present invention summarized as the molded motor including: a stator of annular shape molded with resin; a first case covering one end side of an internal space formed inside the stator; a second case covering the other end side of the internal space; a third case connected to the first case in the internal space; a reduction mechanism arranged in a first space formed between the first case and the third case; and a rotor arranged in a second space formed between the second case and the third case, wherein the first case includes a ring partition lira formed on a surface facing the first space, and the third case is engaged with the partition unit.

According to a molded motor based on a characteristic of the present invention, it is possible to easily partition an interior space of a stator into a first space in which a reduction mechanism is arranged and a second space in which a rotor is arranged by a partition unit. This makes it possible to inhibit oil injected inside the reduction mechanism from being leafed from the first space to the second space. As a result, it is possible to appropriately contain the reduction mechanism in the molded motor.

In the molded motor according to the aspect of the present invention, the molded motor may further include: a first through hole penetrating the partition unit from the first space to the second space, and a second through hole penetrating the first case from the first through hole to an exterior.

In the molded motor according to the aspect of the present invention, the molded motor may further include: a first continuous hole communicating to the first space and an exterior; and a second continuous hole communicating to the second space and an exterior.

In the molded motor according to the aspect of the present invention, the second through hole may be disposed above the center of the stator, in a state where the molded motor is attached.

In the molded motor according to the aspect of the present invention the molded motor may further include: a tubular member of which the one end unit is attached to an external opening unit of the second through hole, wherein the other end unit of the tubular member may be arranged below the external opening unit, in a state where the molded motor is attached.

An electric vehicle according to an aspect of the present invention summarized as the electric vehicle including: a wheel capable of freely rotating and driving; and a molded motor configured to drive the wheel, wherein the molded motor including: a stator of annular shape molded with resin; a first case covering one end side of an internal space formed inside the stator; a second case covering the other end side of the internal space, a third case connected to the first case in the internal space; a reduction mechanism arranged in a first space formed between the first case and the third case; and a rotor arranged in a second space formed between the second case and the third case, the first case includes a ring partition unit formed on the first space side, and the third case is engaged with the partition unit.

### BRIEF DESCRIPTION OF THE DRAWINGS

FIG. 1 is a right side view of an electric motorcycle 1 according to an embodiment of the present invention.

FIG. 2 is a left side view of the electric motorcycle 1 according to the embodiment of the present invention.

FIG. 3 is a plan view of a molded motor 5 seen from an output side, according to the embodiment of the present invention.

FIG. 4 is a top view of the molded motor 5 according to the embodiment of the present invention.

FIG. 5 is a perspective view of the molded motor 5 according to the embodiment of the present invention.

FIG. 6 is a cross sectional view taken along the A-A line in FIG. 3.

FIG. 7 is an enlarged view of a B portion in FIG. 6.

FIG. 8 is a diagram explaining the configuration of a first motor case 52 according to the embodiment of the present invention.

FIG. 9 is a diagram explaining the configuration of a continuous hole according to the embodiment of the present invention.

FIG. 10 is a diagram explaining a mounted state of the molded motor 5 according to the embodiment of the present invention.

### BEST MODES FOR CARRYING OUT THE INVENTION

Next, with reference to the drawings, an embodiment of the present invention will be described. In the following description of the drawings, the same or similar parts will be denoted by the same or similar reference numerals. However, it should be noted that the drawings are schematic and ratios of respective dimensions and the like are different from actual ones. Therefore, the specific dimensions, etc., should be determined in consideration of the following explanations. Moreover, as a matter of course, also among the drawings, there are included portions in which dimensional relationships and ratios are different from each other.

### (Schematic Configuration of Electric Vehicle)

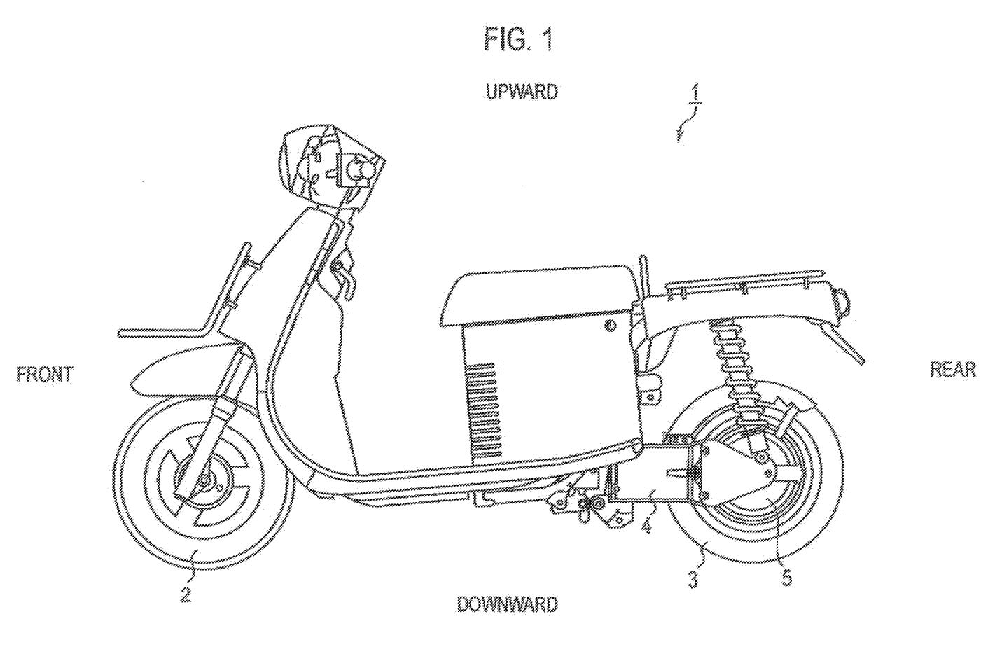

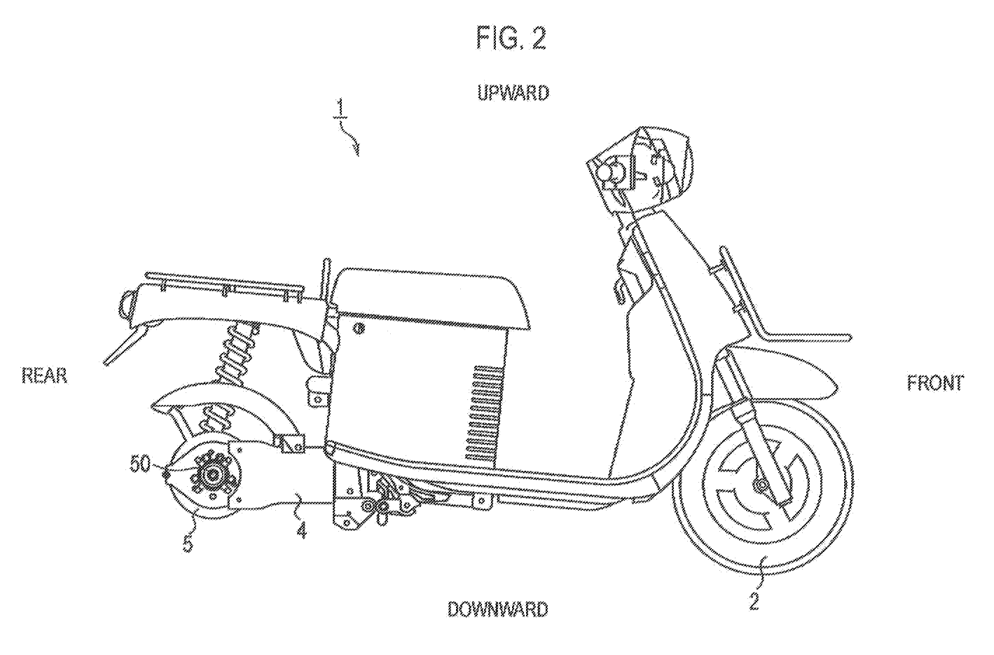

With reference to the drawings, description will be given below of an electric motorcycle 1 that is an electric vehicle to which a molded motor according to the present invention is applied. FIG. 1 is a right side view of the electric motorcycle 1. FIG. 2 is a left side view of the electric motorcycle 1. It is noted that FIG. 2 illustrates a state where a rear wheel 3 is removed in order to explain a mounted state of a molded motor 5.

As illustrated in FIG. 1, the electric motorcycle 1 is a so-called under-bone type electric motorcycle having a vehicle body frame provided on the lower side. The electric motorcycle 1 includes a front wheel 2, a rear wheel 3, a swing arm 4, and a molded motor 5.

The front wheel 2 is rotatably supported by a front fork. The rear wheel 3 is rotatably supported by the swing arm 4. The swing arm 4 is swingably attached to the vehicle body frame.

The molded motor 5 is fixed to the swing arm 4, as illustrated in FIG. 2. A driving force generated by the molded motor 5 is transmitted to the rear wheel 3 not shown, through a motor shaft 50 arranged approximately in the center of the molded motor 5. The molded motor 5 is a geared motor with a built-in reduction mechanism. A configuration of the molded motor 5 will be described later.

### (Configuration of Molded Motor)

With reference to the drawings, description will be given below of the configuration of the molded motor according to the embodiment. Note that, in the following description, an “output side” is a side of the molded motor 5 where the motor shaft 50 is connected to the rear wheel 3 and an “opposite output side” is a side opposite to the output side of the molded motor 5.

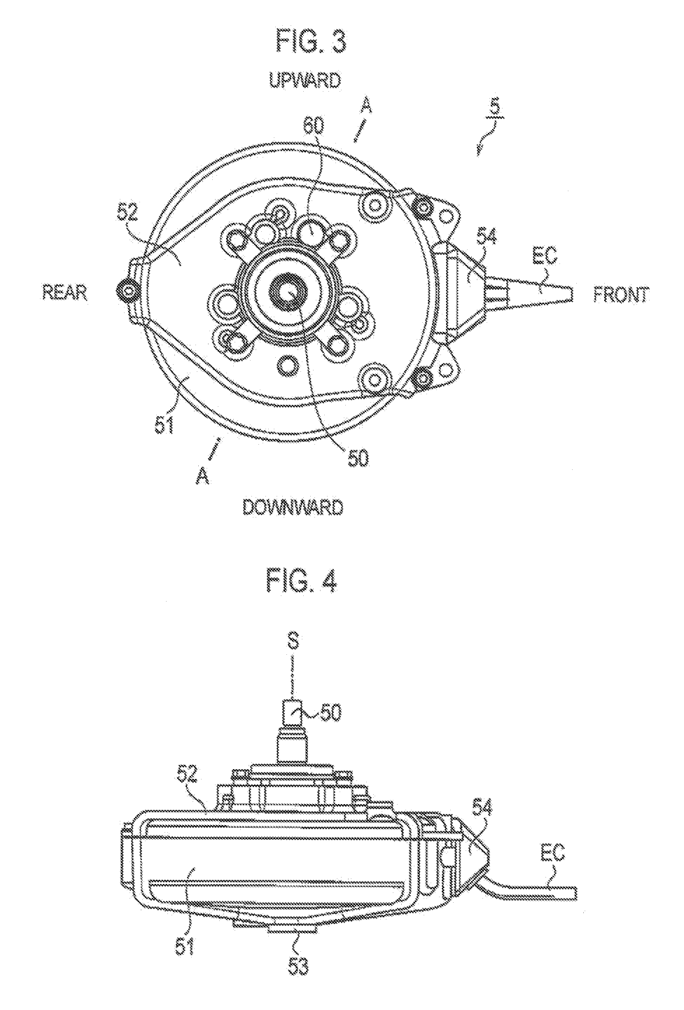

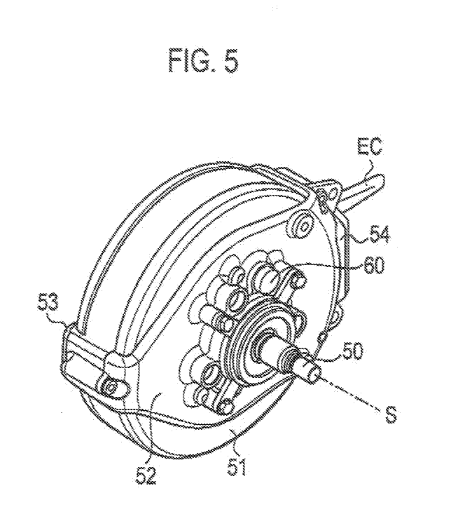

FIG. 3 is a plan view of the molded motor 5 seen from the output side. FIG. 4 is a top view of the molded motor 5. FIG. 5 is a perspective view of the molded motor 5. It should be noted that the illustration of FIG. 3 is such that the molded motor 5 is oriented similarly to when the molded motor 5 is attached to the swing arm 4 of the electric motorcycle 1 (see FIG. 2).

As illustrated from FIG. 3 to FIG. 5, the molded motor 5 includes a motor shaft 50, a stator 51, a first motor case 52 (“first case” according to the present invention), a second motor case 53 (“second case” according to the present invention), a terminal box 54, and an air breather 60.

The motor shaft 50 is arranged approximately in the center of the molded motor 5 in a planar view. The motor shaft 50 is inserted through the first motor case 52. The rear wheel 3 is driven by rotation of the motor shaft 50 around a shaft center S.

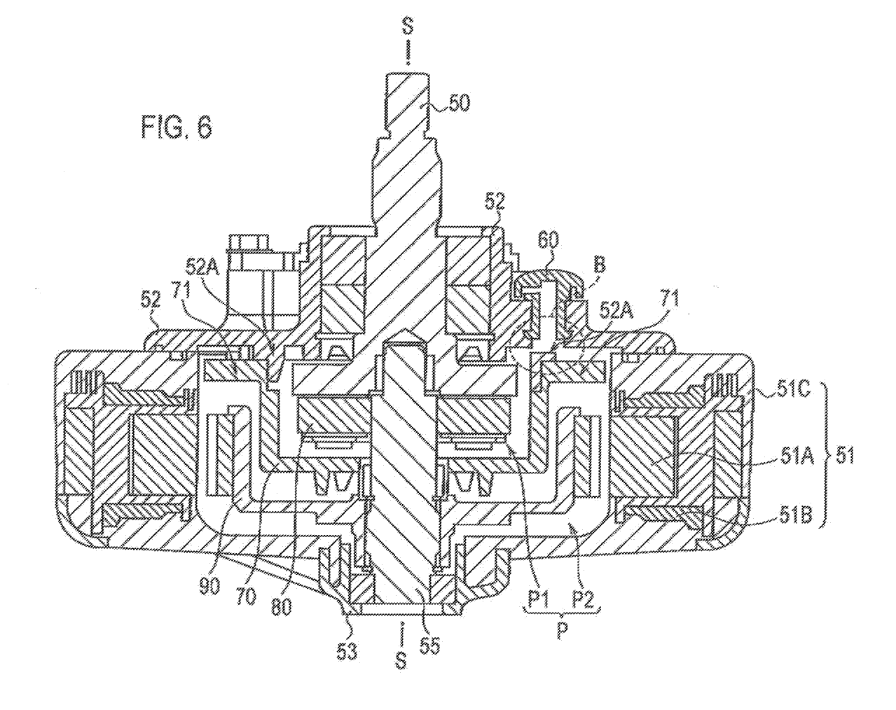

The stator 51 is formed, into an annular shape with the motor shaft 50 as its center. The stator 51 is formed by molding a plurality of teeth 51A aligned on a circle with the shaft center S as the center and coils 51B respectively wound around the plurality of teeth 51A, with a resin molded unit 51C (see FIG. 6). Inside the annular stator 51, a columnar internal space P is formed. An internal structure of the molded motor 5 will be described later.

The first motor case 52 covers an output side of the stator 51 (internal space P). Into the first motor case 52, the motor shaft 50 is inserted. The first motor case 52 is screwed to the swing arm 4.

The second motor case 53 is arranged at the opposite output side of the stator 51 (internal space P). As illustrated in FIG. 3 and FIG. 5, the first motor case 52 and the second motor case 53 are screwed each other.

The terminal box 54 stores the end of a cable EC connected to a battery. Normally, the battery is disposed under a seat.

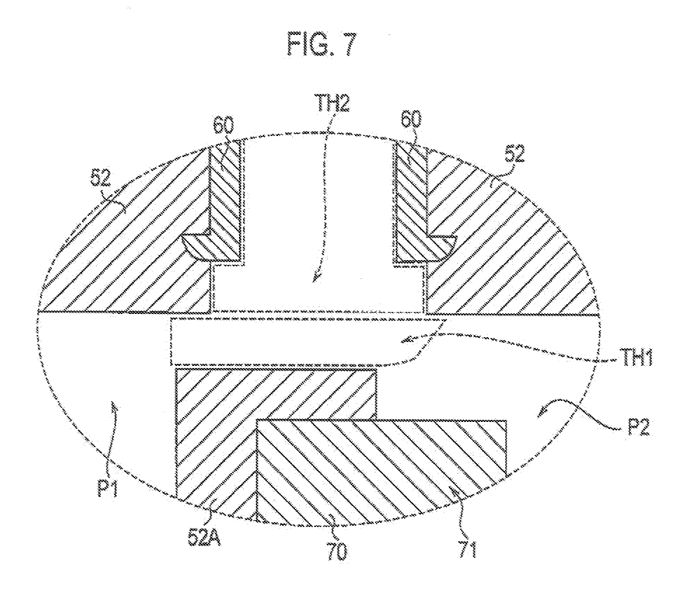

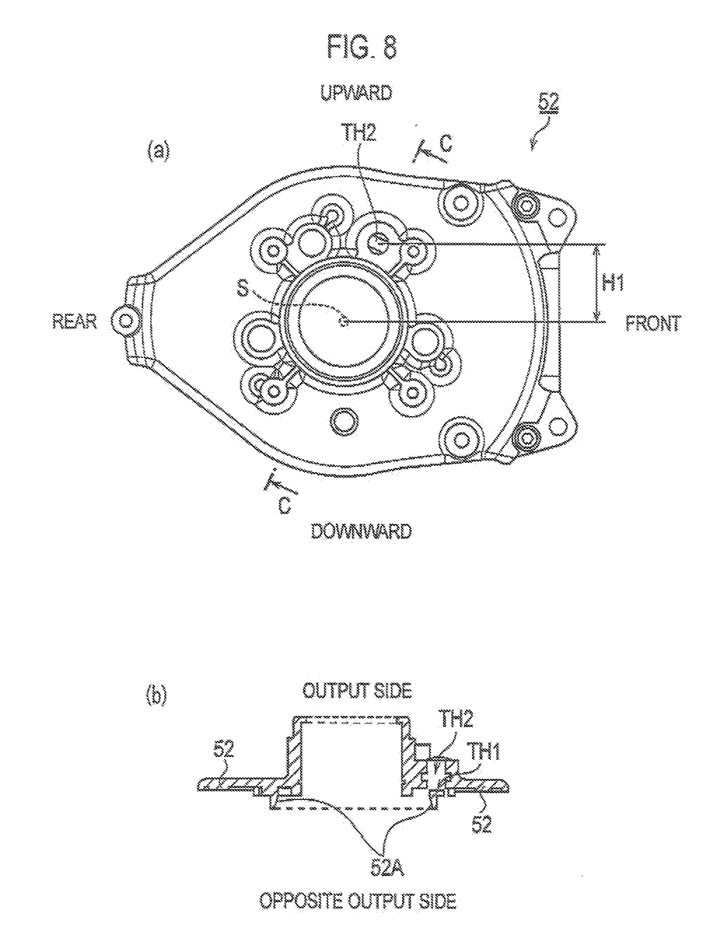

The air breather 60 is a cap fitted into a through hole TH2 (see FIG. 7) formed in the first motor case 52. The configuration of the through hole will be described later. The air breather 60 is configured by a rubber member, for example, and functions as one portion of an fair Row for inhibiting an air pressure change inside the internal space P in an air-tight state. Specifically, air inside the internal space P is inflated as a result of the temperature inside the internal space P rising along with the operation of the molded motor 5. The air inflated inside the internal space P is exhausted to outside via the air breather 60.

### (Internal Structure of Molded Motor)

With reference to the drawings, description will be given below of the internal structure of the molded motor 5.

FIG. 6 is a cross-sectional view taken along the A-A line in FIG. 3. As illustrated in FIG. 6, the molded motor 5 includes a gear case 70 (“third case” according to the present invention), a reduction mechanism 80, and a rotor 90, in the internal space P.

The gear case 70 is formed into a dome shape, and is connected to the first motor case 52. Specifically, the first motor case 52 has an annular partition unit 52A formed on the surface on the gear ease 70 side. A guard-shaped portion 71 forming an opening of the gear case 70 is engaged with the partition unit 52A of the first motor case 52. The gear case 70 (guard-shaped portion 71) is screwed to the first motor case 52. As a result, the internal space P is partitioned into a first space P1 formed between the first motor case 52 and the gear case 70 and a second space P2 formed between the second motor case 58 and the gear case 70.

The reduction mechanism 80 is disposed in the first space P1. The reduction mechanism 80 transmits the revolution of the rotor 90 which is transmitted via the gear shaft 55, to the motor shaft 50, reducing by a predetermined reduction ratio.

The rotor 90 is disposed in the second space P2. The rotor 90 revolves around the shaft center S. The revolution of the rotor 90 is transmitted to the reduction mechanism 80 via the gear shaft 55 inserted through the center of the rotor 90.

The stator 51 includes a plurality of teeth 51A aligned on a circle with the shaft center S as the center, coils 51B respectively wound around the plurality of teeth 51A, and an annular resin molded unit 51C configured to mold the plurality of teeth 51A and the coils 51B. It should be noted that one portion of the resin molded with 51C forms the bottom of the stator 51. Therefore, the opposite output side of the internal space P is covered by one portion of the resin molded unit 51C and the second motor case 53. Thus, in this embodiment, one portion of the resin molded unit 51C and the second motor case 53 configure the “second case” according to the present invention.

### (Configuration of Through Hole)

With reference to the drawings, description will be given below of the configuration of the through hole formed in the first motor case 52.

FIG. 7 is an enlarged view of a B portion in FIG. 6. As illustrated in FIG. 7, in the first motor case 52, a first through hole TH1 and a second through hole TH2 are formed.

The first through hole TH1 is formed to penetrate the partition unit 52A from the first space P1 to the second space P2.

The second through, hole TH2 is formed to penetrate the first motor case 52 from the first through hole TH1 to outside.

When temperatures within the first space P1 and the second space P2 rise, air within the first space P1 and the second space P2 goes through the first through hole TH1 and the second through hole TH2 to be exhausted to outside from the air breather 60. Moreover, when the temperatures within the first space P1 and the second space P2 fall, an external air flown in from the air breather 60 goes through the first through hole TH1 and the second through hole TH2 to flow inside the first space P1 and the second space P2.

### (Configuration of First Motor Case 52)

With reference to the drawings, description will be given below of the configuration of the first motor case 52.

FIG. 8(a) is a plan view of the first motor case 52 seen from the output side. FIG. 8(b) is a cross-sectional view taken along the C-C line in FIG. 8(a). It should be noted that the illustration of FIG. 8(a) is such that the first motor case 52 is oriented similarly to when the molded motor 5 is attached to the swing arm 4 of the electric motorcycle 1 (see FIG. 2).

As illustrated in FIG. 8(a), the second through hole TH2 is exposed on a surface (output side surface) facing the first space P1 of the first motor case 52. Into the second through hole TH2, the aforementioned air breather 60 is fitted.

The second through, hole TH2 is disposed above the center (shaft center S) of the stator 51, in a state where the molded motor 5 is attached to the electric motorcycle 2 as illustrated in FIGS. 2 and FIG. 8(a). Specifically, the second through hole TH2 is disposed, at a higher position by a height H1 than the center (shaft center S) of the stator 51. It should be noted that the center (shaft center S) of the stator 51 is illustrated virtually in FIG. 8(a).

As illustrated in FIG. 8(b), the partition unit 52A protruding to the opposite output side is formed on the opposite output side surface of the first motor case 52. The partition unit 52A is formed into a ring shape and used as a partition to partition the internal space P into two spaces. Specifically, as described above, the gear case 70 is fitted into the partition unit 52A, and thus, the internal space P is partitioned into the first space P1 and the second space P2.

The first through hole TH1 is formed in the partition unit 52A, and the second through hole TH2 is formed in the first motor case 52 (main body).

### (Operation and Effect)

In the molded motor 5 according to the embodiment, the first motor case 52 includes the ring partition unit 52A formed on the surface facing the first space P1 formed between the first motor case 52 and the gear case 70. The gear case 70 (guard-shaped portion 71) is engaged with the first motor case 52 (partition unit 52A). The gear case 70 (guard-shaped portion 71) is screwed to the first motor case 52.

That is, as a result of the engagement between the guard-shaped portion 71 of the gear case 70 and the partition unit 52A of the first motor case 52, the gear case 70 and the first motor case 52 (partition unit 52A) can easily partition the internal space P of the stator 51 into the first space P1 in which the reduction mechanism 80 is arranged and the second space P2 in which the rotor 90 is arranged. Thus, it is possible to inhibit the oil injected inside the reduction mechanism 80 from being leaked out from the first space P1 to the second space P2. As a result, it is possible to appropriately contain the reduction mechanism 80 in the molded motor 5.

Further, the molded motor 5 (first motor case 52) according to the embodiment includes the first through hole TH1 penetrating the partition unit 52A from the first space P1 to the second space P2 and the second through hole TH2 penetrating the first motor case 52 from the first through hole TH1 to outside.

Therefore, when the temperatures within the first space P1 and the second space P2 rise, it is possible to exhaust the air within the first space P1 and the second space P2 to outside, when the temperatures within the first space P1 and the second space P2 fall, it is possible to flow in the external air to inside the first space P1 and the second space P2. As a result, it is possible to inhibit an air pressure change inside the internal space P.

Further, in the molded motor 5 according to the embodiment, the second through hole TH2 is disposed above the center (shaft center 8) of the stator 51, in a state where the molded motor 5 is attached to the swing arm 4 of the electric motorcycle 1, as illustrated in FIG. 2, for example. Therefore, it is possible to inhibit the oil injected inside the reduction mechanism 80 from being leaked out, through the first through hole TH1 and the second through hole TH2, from the second through hole TH2 to outside.

### (First Modification of the Embodiment)

With reference to the drawings, description will be given below of a first modification of the above-described embodiment. The explanation below is based primarily on a difference from the above-described embodiment. Specifically, in this modification, the molded motor 5 includes a first continuous hole TS1 and a second continuous hole TS2 instead of the first through hole TH1 and the second through hole TH2.

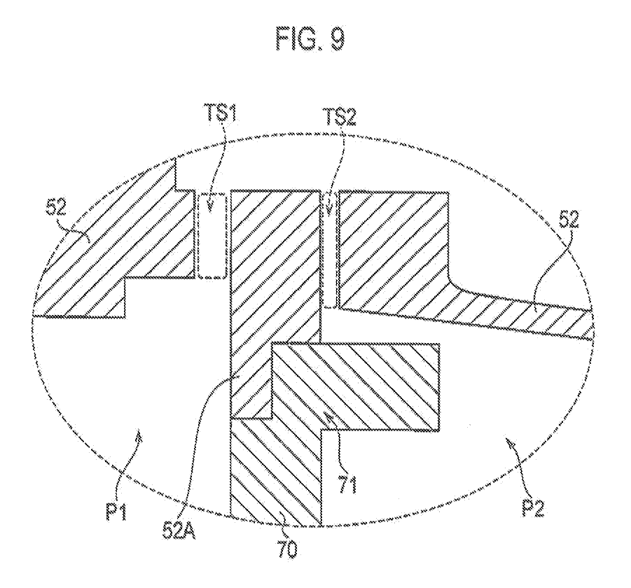

FIG. 9 is an enlarged cross-sectional view explaining the configuration of the continuous hole according to this modification. As illustrated in FIG. 9, in the first motor case 52, the first continuous hole TS1 communicating to the first space P1 and the exterior and the second continuous hole TS2 communicating to the second space P2 and exterior are formed.

Air inside the first space P1 is exhausted to outside vie the first continuous hole TS1, and the external air flows inside the first space P1 via the first continuous hole TS1. Likewise, air inside the second space P2 is exhausted to outside vie the second continuous hole TS2, and the external air flows inside the second space P2 via the second continuous hole TS2.

It is noted that an air breather may be fitted into each of the first continuous hole TS1 and the second continuous hole TS.

### (Operation and Effect)

The molded motor 5 according to a first modification includes the first continuous hole TS1 communicating to the first space P1 and the exterior and the second continuous hole TS2 communicating to the second space P2 and the exterior.

Therefore, when the temperatures within the first space P1 and the second space P2 rise, it is possible to exhaust the sir within the first space P1 and the second space P2 to outside, when the temperatures within the first space P1 and the second space P2 fall, it is possible to flow the external air to inside the first space P1 and the second space P2. As a result, it is possible to appropriately inhibit an air pressure change inside the internal space P.

### (Second Modification of the Embodiment)

With reference to the drawings, description will be given below of a second modification of the above-described embodiment. The explanation below is based primarily on a difference from the above-described embodiment. Specifically, in this modification, the molded motor 5 includes a tubular member 100 attached to an external opening unit of the second through hole TH2.

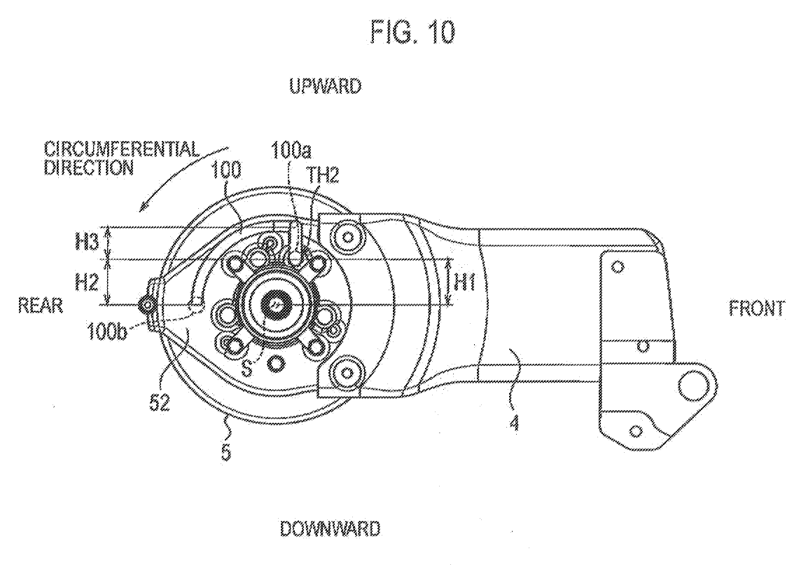

FIG. 10 is a diagram explaining a mounted state of the molded motor 5 according to this modification. It should be noted that the illustration of FIG. 10 is such that assemblies of the swing arm 4 and the molded motor 5 which are orientation similarly to when the molded motor 5 is attached to the swing arm 4 of the electric motorcycle 1 (see FIG. 2).

As illustrated in FIG. 10, one end unit 100a of the tubular member 100 is attached to the external opening unit TH21 of the second through hole TH2. The tubular member 100 is extended along the outer edge of the first motor case 52, and the other end unit 100b of the tubular member 100 is arranged below the external opening unit TH21 of the second through hole TH2.

The tubular member 100 is configured of rubber and plastic, for example. Specifically, the tubular member 100 is disposed to extend toward an upward direction by a height H3 from the external opening unit TH21 of the second through hole TH2, and further, to extend in an arc shape along a circumferential direction of the molded motor 5 (stator 51). It is noted that the tubular member 100 is disposed in, the first motor case 52 by a jig arranged in the first motor case 52, for example.

The other end unit 100b of the tubular member 100 is disposed at a lower position by a height H2 than one end unit 100a of the tubular member 100. Further, the other end unit 100b of the tubular member 100 is disposed at a lower position by heights H2+H3 than the highest portion of the tubular member 100.

It is noted that the second through hole TH2 (external opening TH21) is disposed above the center (shaft center S) of the stator 51, in a state where the molded motor 5 is attached to the electric motorcycle 2, as illustrated in FIG. 2 and FIG. 10. Specifically, the second through hole TH2 (external opening TH21) is disposed at a higher position by a height H1 from the center (shaft center S) of the stator 51.

### (Operation and Effect)

The molded motor 5 according to the second modification includes a tubular member 100 of which the one end unit is attached to the external opening unit of the second through hole TH2. The other end unit of the tubular member 100 is arranged below the external opening unit of the second through hole TH2.

Therefore, it is possible to inhibit dusts or water from entering the interior of the molded motor 5 from the second through hole TH2.

### Other Embodiments

Although the present invention has been described with reference to the above embodiments, it should be understood that the present invention is not limited to the description and drawings which constitute a part of this disclosure. From this disclosure, various alternative embodiments, examples and operational technologies will become apparent to those skilled in the art.

For example, in the above-described embodiment, a case where the molded motor 5 is applied to the electric motorcycle 1 is described; however, the application of the molded motor 5 is not always limited thereto. For example, the molded motor 5 can be applied to an air blower, a washing machine, etc.

Moreover, in the above-described embodiment, one portion of the resin molded unit 51C and the second motor case 53 configure the “second case” according to the present invention; however, this is not always the case. For example, the resin molded unit 51C may be farmed in a donut shape, and in addition, the second motor case 53 may cover the opposite output side of the internal space P. In this case, the “second case” according to the present invention is configured of the second motor case 53 only.

As described above, it should be understood that the present invention includes various embodiments and the like which are not described herein. Therefore, the present invention is limited only by items specific to the invention according to claims pertinent based on the foregoing disclosure.

### ADVANTAGEOUS EFFECTS OF INVENTION

According to the present invention, it is possible to provide a molded motor with a built-in reduction mechanism and an electric vehicle with a built-in reduction mechanism.

1. A molded motor, comprising:
a stator of annular shape molded with resin;
a first case covering one end side of an internal space formed inside the stator;
a second case covering the other end side of the internal space;
a third case connected to the first case in the internal space;
a reduction mechanism arranged in a first space formed between the first case and the third case; and
a rotor arranged in a second space formed between the second case and the third case, when
the first case includes a ring partition unit formed on a surface facing the first space, and
the third case is engaged with the partition unit.

2. The molded motor according to claim 1, further comprising:
a first through hole penetrating the partition unit from the first space to the second space; and
a second through hole penetrating the first case from the first through hole to an exterior.

3. The molded motor according to claim 1, further comprising:
a first continuous hole communicating to the first space and an exterior; and
a second continuous hole communicating to the second space and an exterior.

4. The molded motor according to claim 2, wherein
the second through hole is disposed above the center of the stator, in a state where the molded motor is attached.

5. The molded motor according to claim 2, further comprising a tubular member of which the one end unit is attached to an external opening unit of the second through hole, wherein the other end unit of the tubular member is arranged below the external opening unit, in a state where the molded motor is attached.

6. An electric vehicle, comprising:
a wheel capable of freely rotating and driving; and
a molded motor configured to drive the wheel, wherein
the molded motor comprises:
a stator of annular shape molded with resin;
a first case covering one end side of an internal space formed inside the stator;
a second case covering the other end side of the internal space;
a third case connected to the first case in the internal space;
a reduction mechanism arranged in a first space formed between the first case and the third case; and
a rotor arranged in a second space formed between the second case and the third case,
the first case includes a ring partition unit formed on the first space side, and
the third case is engaged with the partition unit.
